(19) United States
(12) Patent Application Publication
(10) Pub. No.: US 2017/0090500 A1
(43) Pub. Date: Mar. 30, 2017

(54) Voltage Converter Circuitry Having Permanent Magnet Structures

(71) Applicant: Apple Inc., Cupertino, CA (US)

(72) Inventor: Sunil M. Akre, Santa Clara, CA (US)

(21) Appl. No.: 14/994,843

(22) Filed: Jan. 13, 2016

Related U.S. Application Data
(60) Provisional application No. 62/234,417, filed on Sep. 29, 2015.

(51) Int. Cl. G05F 3/06

(52) U.S. Cl. CPC G05F 3/06

(57) ABSTRACT

An electronic device may include electrical components. Each component may be powered at a different respective voltage. Voltage converter circuitry may convert a power supply input voltage into a suitable voltage for powering a corresponding component. The converter may include permanent magnets that include hard ferromagnetic materials. An inductor may be formed adjacent to the permanent magnets and within the magnetic field. The magnetic field may contribute to the inductance of the inductor. The inductor may be coupled between power switching circuitry and an output path. The power switching circuitry may receive the input voltage and may apply a duty cycle to the input voltage to generate an intermediate signal. The inductor may generate an output voltage having a different magnitude than the input voltage based on the intermediate signal. The inductor may provide the output voltage to the electrical component over the output path for powering the electrical component.

This application claims the benefit of provisional patent application No. 62/234,417 filed on Sep. 29, 2015, which is hereby incorporated by reference herein in its entirety.

### BACKGROUND

This relates generally to power converter circuitry, and, more particularly, to very high frequency switch-mode power converter circuitry incorporating permanent magnets to enhance inductivity of air-core inductors.

Electronic devices typically include electrical components such as processing circuits, input-output devices, memory devices, and other components. The electrical components are powered using different levels of direct current (DC) voltage. Voltage converter circuitry is used to convert a device power supply voltage to a suitable DC voltage for powering each of the electrical components. The voltage converter circuitry typically includes an inductor that exhibits a corresponding inductance.

In general, an inductor having a higher inductance provides more stable voltage conversion for the voltage converter circuitry than an inductor having a lower inductance. In conventional voltage converter circuitry, the inductance of the inductor is increased to a sufficient level by increasing the physical size of the inductor. However, to satisfy consumer demand for small form factor electronic devices, manufacturers are continually striving to implement device circuitry using compact structures. One approach is to increase switching frequency of the power converter circuitry, allowing for smaller components and the possibility of implementing air-core filter inductors.

It would therefore be desirable to be able to provide small form factor air-core inductors with improved inductivity.

### SUMMARY

An electronic device may include electrical components. Each electrical component may be powered at a different respective voltage. The device may include voltage converter circuitry. The voltage converter circuitry may convert an input voltage such as a device power supply voltage into a suitable voltage for powering a corresponding electrical component.

The converter circuitry may include magnet structures such as one or more permanent magnets. The permanent magnets may produce a corresponding magnetic field at corresponding north and south pole surfaces of the magnets. A conductive line such as an inductor (e.g., an air-core type inductor) may be placed adjacent to the permanent magnets and within the magnetic field. The permanent magnets may include hard ferromagnetic material (e.g., without any soft ferromagnetic material). The magnetic field may contribute to a total inductance of the inductor. The converter circuitry may include control circuitry that receives input voltage. The control circuitry may include power switching circuitry that controls transfer of power from an input to an output that is filtered using capacitive and/or inductive components. For example, the power switching circuitry may receive the steady input voltage and convert it a switching signal.

An inductor filters the switching signal to generate steady output voltage based on the duty-cycle of the switching signal. The output voltage may have a different magnitude than the input voltage. The inductor may provide the output voltage to the electrical component over the output path for powering the electrical component. The inductor may include, for example, a number of straight wires coupled in parallel between the power switching circuitry and the output path. The wires may extend in a direction that is substantially perpendicular to the direction of the magnetic field produced by the permanent magnets. Additional inductors may be coupled between the power switching circuitry and the output path within the magnetic field of the permanent magnets if desired.

In accordance with any of the above arrangements, the voltage converter circuitry may include first and second magnets (e.g., first and second permanent magnets) having corresponding north and south poles. The first and second magnets may be separated by a gap. The first and second magnets may be aligned such that the north pole of the first magnet is separated from the south pole of the second magnet by the gap. The south pole of the first magnet may be separated from the north pole of the second magnet by the gap. The inductor may be placed within the gap and between the north pole of the first magnet and the south pole of the second magnet. If desired, an additional inductor may be placed within the gap and between the south pole of the first magnet and the north pole of the first magnet. The inductors may be coupled to different respective power switching circuits or may be coupled to the same power switching circuit. Both of the inductors may extend in a direction that is substantially perpendicular to the direction of the magnet field of the first and second magnets (e.g., so that magnetic fields produced by the inductors interacts with the magnetic field of the first and second magnets).

In accordance with any of the above arrangements, the electronic device may include a printed circuit or other substrate. The inductor and the power switching circuitry may be formed on a surface of the printed circuit adjacent to the powered electrical component. If desired, one or both of the inductor and the power switching circuitry may be embedded within the printed circuit. Additional voltage converter circuits may be formed on the printed circuit for powering additional electrical components at different voltage levels based on a common input voltage.

Further features will be more apparent from the accompanying drawings and the following detailed description.

### BRIEF DESCRIPTION OF THE DRAWINGS

FIG. 1 is a diagram of an illustrative electronic device that may be provided with voltage converter circuitry in accordance with an embodiment.

FIG. 2 is a diagram of an illustrative printed circuit in an electronic device having multiple voltage converters for powering different device components at different voltage levels in accordance with an embodiment.

FIG. 3 is a diagram of illustrative voltage converter circuitry having permanent magnet structures in accordance with an embodiment.

FIG. 4 is a diagram of an illustrative printed circuit having a powered component and corresponding voltage converter circuitry formed at a surface of the printed circuit in accordance with an embodiment.

FIG. 5 is a diagram of illustrative voltage converter circuitry having a first portion formed at a surface of a printed circuit and a second portion embedded within the printed circuit in accordance with an embodiment.

FIG. 6 is a diagram of illustrative voltage converter circuitry having a first portion formed at a surface of a printed circuit and a second portion formed below a corresponding powered component in accordance with an embodiment.

FIG. 7 is a diagram of illustrative voltage converter circuitry that is embedded within a printed circuit below a powered component on a surface of the printed circuit in accordance with an embodiment.

FIG. 8 is a circuit diagram of illustrative voltage converter circuitry that includes an output filter circuit having permanent magnet structures in accordance with an embodiment.

FIG. 9 is a circuit diagram of illustrative voltage converter circuitry that includes multiple power switching circuits and an output filter having permanent magnet structures in accordance with an embodiment.

FIG. 10 is a diagram of illustrative voltage converter circuitry having inductive structures that may be placed within the magnetic field of permanent magnet structures in accordance with an embodiment.

FIG. 11 is a cross-sectional diagram of voltage converter circuitry of the type shown in FIG. 10 in which inductive structures are placed within the magnetic field of permanent magnet structures in accordance with an embodiment.

### DETAILED DESCRIPTION

An electronic device may be provided with electrical components such as integrated circuits. These components may be mounted to substrates such as one or more printed circuit boards within the device. Components in the electronic device may be powered using direct current (DC) power supply voltages. In general, different DC power supply voltages may be required by different components within the device. For example, a given component in the device may be powered by a 1.0V DC voltage whereas another component may be powered by a 2.0V DC voltage.

The electronic device may include power supply circuitry or other circuitry that provides a common DC voltage for the electronic device that is sometimes referred to herein as a device voltage or a device power supply voltage. The electronic device may include voltage converter circuitry that converts the device power supply voltage to a suitable voltage level for powering each device component. The voltage converter circuitry may, for example, convert a common 12V DC power supply voltage into a 1.0V DC voltage for some device components and may convert the 12V power supply voltage into a 2.0V DC voltage for other device components. The voltage converter circuitry may include, for example, DC/DC converter circuitry, voltage level adjustment circuitry, or any other desired power converter circuitry.

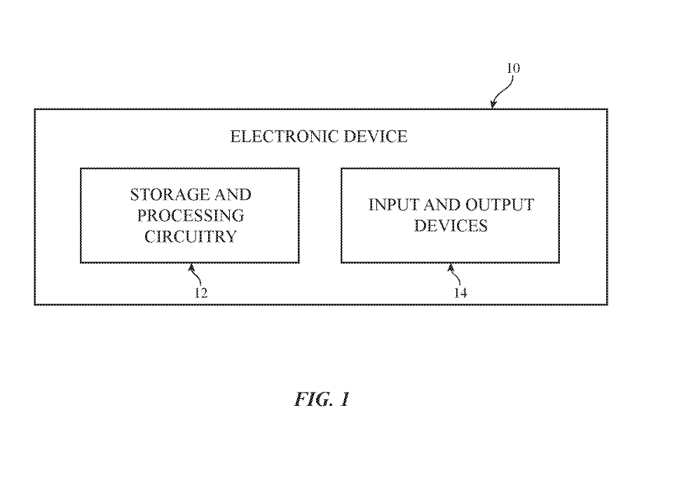

An illustrative electronic device of the type that may be provided with voltage converter circuitry is shown in FIG. 1. Electronic device 10 of FIG. 1 may be a set-top box, a wireless access point, a router, a storage device, a device for providing still and moving images to an attached display such as a television or computer monitor, a cellular telephone, a handheld portable device such as a media player, a somewhat smaller portable device such as a wrist-watch device, a pendant device, other wearable or miniature device, gaming equipment, tablet computer, notebook computer, desktop computers, a server device, television, computer monitor, a computer integrated into a computer display, a hybrid device that includes the functionality of two or more devices such as these, or other electronic equipment.

As shown in FIG. 1, device 10 may include storage and processing circuitry 12. Storage and processing circuitry 12 may include one or more different types of storage such as hard disk drive storage, nonvolatile memory (e.g., flash memory or other electrically-programmable-read-only memory), volatile memory (e.g., static or dynamic random-access-memory), etc. Storage and processing circuitry 12 may be used in controlling the operation of device 10. Processing circuitry in circuitry 12 may be based on processors such as one or more microprocessors, microcontrollers, digital signal processors, dedicated processing circuits, power management circuits, audio and video chips, and other suitable integrated circuits.

Device 10 may include input-output devices 14. Input-output devices 14 may be used to allow data to be supplied to device 10 and to allow data to be provided from device 10 to external devices. If desired, devices 14 may allow power to be supplied to device 10 from an external source such as a wall outlet or power adapter device. Examples of input-output devices 14 that may be used in device 10 include display screens such as touch screens (e.g., liquid crystal displays or organic light-emitting diode displays), buttons, joysticks, click wheels, scrolling wheels, touch pads, key pads, keyboards, microphones, speakers and other devices for creating sound, cameras, sensors, etc. Devices 14 may include connectors or other structures for forming data ports (e.g., for attaching external equipment such as computers, accessories, peripherals, etc.) or powering ports.

Devices 14 may include power supply circuitry or other circuitry for powering components on device 10. For example, devices 14 may include circuitry that receives power from a corresponding power source. Power sources that provide power to device 10 may include, for example, charging devices such as power adapter devices, an alternating current (AC) powering input such as a wall outlet, a direct current powering input, solar power inputs, a battery on device 10, or any other desired power source. Devices 14 may include power supply circuitry that supplies a common DC device power supply voltage for powering components on device 10. If desired, the power supply circuitry may include converter circuitry that converts an AC input power to the common DC device power supply voltage (e.g., AC/DC converter circuitry) for powering the circuitry of device 10. In scenarios where device 10 is coupled to an external power adapter device, device 10 may receive the DC device power supply voltage from AC/DC converter circuitry in the power adapter device.

Device 10 may include internal structures such as printed circuits. Electrical components may be mounted on the printed circuits and may be electrically connected through conductive paths in the printed circuits and in external cables. Printed circuits in device 10 may include rigid printed circuit boards (e.g., printed circuits formed from fiberglass-filled epoxy or other rigid substrate material) and/or flexible printed circuits (e.g., printed circuit substrates formed from flexible polymer layers such as sheets of polyimide.

Electrical components within device 10 may be mounted to printed circuits. Components in device 10 that are mounted to the printed circuits may include power supply components, integrated circuits such as amplifiers, central processing unit (CPU) integrated circuits, and other integrated circuits, memory or storage devices, input/output devices, wireless circuits, sensors, connectors, and other electrical components. One or more components (e.g., integrated circuits) from storage and processing 12 and/or input-output devices 14 may be formed on printed circuits within device 10. For example, a CPU integrated circuit and a memory device from storage and processing circuitry 12 may be formed on a common printed circuit board (e.g., a motherboard or other device board) as a sound card device, a video card device, and other input-output devices from devices 14. In general, device 10 may include any desired number of printed circuits on which any desired number of electrical components are formed. The example in which electrical components in device 10 are formed on printed circuits is merely illustrative. In general, electrical components in device 10 may be formed on any desired component substrate (e.g., dielectric substrates, plastic substrates, semiconductor substrates, ceramic substrates, polymer substrates, glass substrates, combinations of these, etc.).

Power supply circuitry on device 10 may provide a DC device power supply voltage for powering each of the electrical components on device 10. In practice, different electrical components on device 10 may require different respective DC power supply voltages. Device 10 may include one or more voltage converter circuits for converting the common DC device power supply voltage to different suitable voltages for powering each of the electrical components in device 10.

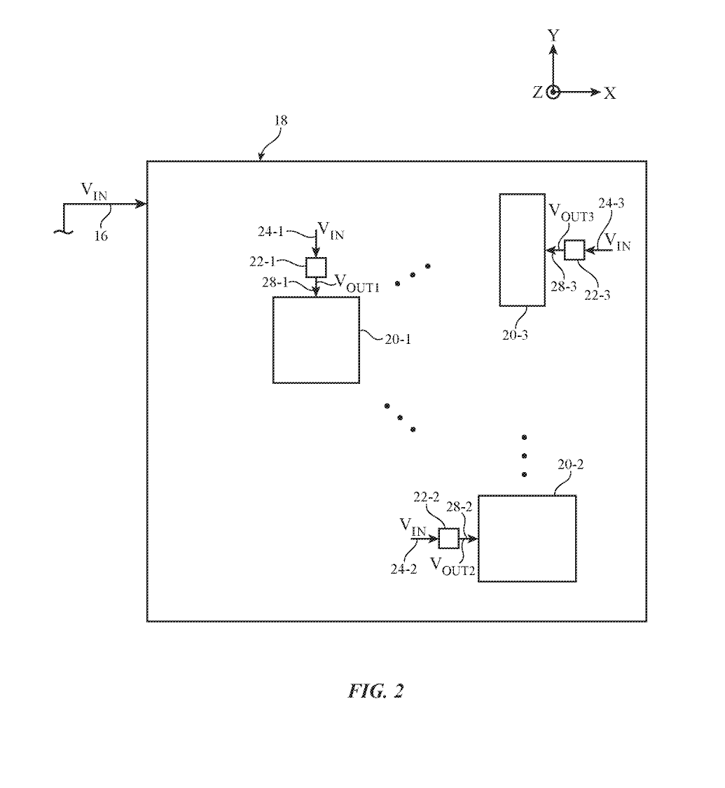

FIG. 2 is a diagram showing how multiple voltage converter circuits may be used for providing power supply voltages to different electrical components within device 10. As shown in FIG. 2, a number of electrical components 20 may be formed on a common substrate 18 (e.g., a first component 20-1, a second component 20-2, a third component 20-3, etc.). Substrate 18 may be, for example, a printed circuit board or other substrate. Components 20 may include circuitry from storage and processing circuitry 12 and/or input-output devices 14 of FIG. 1 if desired. For example, first component 20-1 may be a CPU integrated circuit (chip) whereas second component 20-2 is a wireless transceiver integrated circuit and third component 20-3 is a memory device. Each of components 20-1, 20-2, and 20-3 may be powered using a different DC voltage. For example, component 20-1 may require a 1.0V DC power supply voltage whereas component 20-2 requires a 2.0V DC power supply voltage and component 20-3 requires a 0.5V DC power supply voltage.

Printed circuit 18 may receive a DC device power supply such as voltage V_{IN} over power supply line 16. Device supply voltage V_{IN} may be received from a DC power input on device 10, a DC power supply such as AC/DC converter circuitry or a battery on device 10, an external power adapter device, or any other desired DC power source on or external to device 10. Device power supply voltage V_{IN} may be provided to a conductive power supply line (e.g., a conductive trace or other interconnect) or a conductive power supply plane within printed circuit 18. Printed circuit 18 may, for example, include a number of vertically-stacked substrate layers. Conductive traces or wiring layers may be formed on one or more of the substrate layers to route signals laterally across printed circuit 18. Vertical conductive interconnects such as solder balls, conductive pillars, conductive pins or springs, conductive through-vias, or other interconnects may electrically couple conductors on a given substrate layer to conductors on another substrate layer in printed circuity 18. In one suitable arrangement, a conductive power supply plane may be formed on one of the substrate layers in printed circuit 18. The power supply plane may extend laterally across device 18. The conductive power supply plane may convey power supply voltage V_{IN} across printed circuit 18. Conductive vias or other vertical interconnects may be coupled to the power supply plane for providing power to circuitry formed on printed circuit 18 at one or more locations on printed circuit 18.

In one suitable example that is sometimes described herein as an example, device power supply voltage V_{IN} is provided at 12V. In general, device power supply voltage V_{IN} may be provided at any desired voltage. Components 20 may be powered using voltages that are different from device power supply voltage V_{IN}. Each component 20 may be coupled to a corresponding voltage converter circuit 22 (e.g., first component 20-1 may be coupled to first voltage converter 22-1, second component 20-2 may be coupled to second voltage converter 22-2, third component 20-3 may be coupled to third voltage converter 22-3, etc.). Voltage converter circuits 22 may receive device power supply voltage V_{IN} over a corresponding input 24 (e.g., converter 22-1 may receive voltage V_{IN} over input 24-1, converter 22-2 may receive voltage V_{IN} over input 24-2, etc.). Inputs 24 may include vertical conductive through via structures, wiring structures, conductive traces, or any other desired conductive interconnects that are coupled to the power supply plane of printed circuit 18.

Voltage converter circuits 22 may convert device power supply voltage V_{IN} to a corresponding component power supply voltage V_{OUT} suitable for powering the corresponding component 20. For example, first voltage converter 22-1 may convert voltage V_{IN} to a first component powering voltage V_{OUT1} (e.g., 1.0V), second voltage converter 22-2 may convert voltage V_{IN} to a second component powering voltage V_{OUT2} (e.g., 2.0V), and third voltage converter 22-3 may convert voltage V_{IN} to a third component powering voltage V_{OUT3} (e.g., 0.5V). Component powering voltages V_{OUT} may be provided for powering the components 20 over a corresponding component power input line 28 (e.g., converter 22-1 may provide voltage V_{OUT1} to component 20-1 over path 28-1, converter 22-2 may provide voltage V_{OUT2} to component 20-2 over path 28-2, etc.).

In practice, it may be desirable to form voltage converters 22 as close to the corresponding component 20 as possible in order to minimize losses associated with powering components 20. In this way, converters 22 may serve as so-called point-of-load (POL) converters for components 20. Voltage converters 22 may sometimes be referred to herein as voltage converter circuits 22, POL converters 22, DC/DC converters 22, DC/DC converter circuits 22, or power converter circuits 22.

The example of FIG. 2 is merely illustrative. In general, any desired number of components 20 may be formed on printed circuit 18. For example, one, two, four, or more than four device components 20 may be formed on printed circuit 18. Each device component 20 may be provided with a corresponding voltage converter circuit 22 for powering that component based on device power supply voltage V_{IN}. If desired, a single voltage converter circuit 22 may be used to power multiple device components 20 (e.g., in scenarios where two or more device components are formed relatively close together on printed circuit 18). Other components that are not provided with a corresponding voltage converter circuit 22 may be formed on printed circuit 18. If desired, components 20 and converters 22 need not be formed on a corresponding printed circuit 18 (e.g., components 20 and converters 22 may be formed on different substrates, without any substrates, etc.).

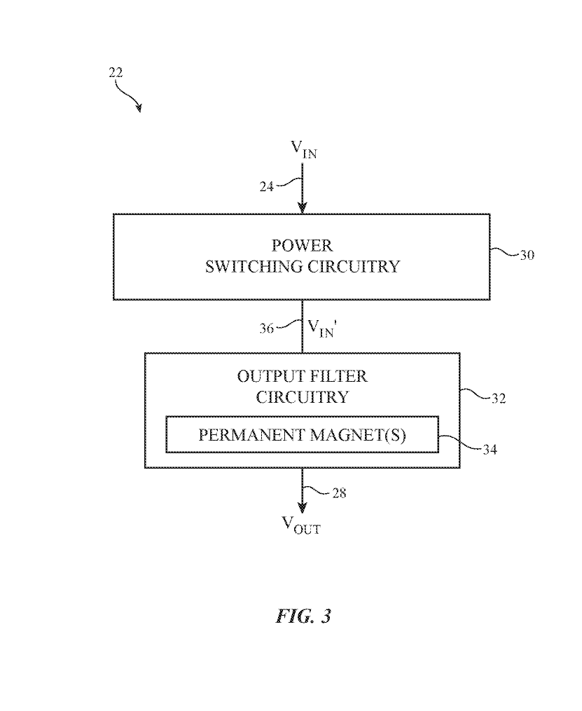

FIG. 3 is a schematic diagram showing an illustrative voltage converter circuit 22. As shown in FIG. 3, voltage converter circuit 22 may include power switching circuitry 30 and output filter circuitry 32. Power switching circuitry 30 may receive device power supply voltage V_{IN} over input path 24. Power switching circuitry 30 may be coupled to output filter circuitry 32 over intermediate path 36. Output filter circuitry 32 may include one or more inductive components (e.g., one or more inductors) and capacitive components (e.g., one or more capacitors). Power switching circuitry 30 may apply a desired duty cycle to input voltage V_{IN} by toggling switches coupled to paths 24 and 36 to generate intermediate signal V_{IN}′. Intermediate signal V_{IN}′ may be a periodic waveform that cycles between a high voltage (e.g., voltage V_{IN}) and a low voltage (e.g., zero volts or another voltage such as a ground voltage) with a frequency given by the duty cycle applied by switching circuitry 30. By providing signal V_{IN}′ with a desired duty cycle, power switching circuitry 30 may cyclically store and release energy in output filter circuitry 32.

Switching circuitry 30 may adjust the duty cycle of intermediate signals V_{IN}′ to adjust the power transferred onto output line 28. In general, higher duty cycles may result in a greater output voltage V_{OUT} than lower duty cycles. Power switching circuitry 30 may adjust the duty cycle of intermediate signals V_{IN}′ so that output voltage V_{OUT} is provided at a desired level (e.g., at 1.0V for powering component 20-1, at 2.0V for powering component 20-2, at 0.5V for powering component 20-3, etc.). Power switching circuitry 30 may, for example, include an integrated circuit or other semiconductor circuit. Output filter circuitry 32 may be formed as a part of the integrated circuit on which power switching circuitry 30 is formed or may be formed separate from the integrated circuit.

The value of the inductance of inductive components within output filter 32 may affect the voltage conversion performance of converter circuitry 22 in generating suitable output signals V_{OUT}. Ideally, output signal V_{OUT} is provided at a constant DC voltage. In practice, output signal V_{OUT} may exhibit slight peak-to-peak variation over time around a given voltage level (e.g., due to the cyclic variation in signal V_{IN}′ generated by switching circuitry 30). It may be desirable to minimize the amount of peak-to-peak variation in output signal V_{OUT} (e.g., to approximate a constant DC voltage as precisely as possible). As an example, it may be desirable to limit the peak-to-peak variation in signal V_{OUT} to 2% or less of the average magnitude of signal V_{OUT}. In general, greater values of inductance in output filter 32 generate less peak-to-peak variation in output voltage V_{OUT} than lesser values of inductance. It may therefore be desirable to provide inductors in output filter circuitry 32 with suitably high inductance values (e.g., to meet a predetermined minimum threshold requirement for peak-to-peak variations in the output signal).

In some scenarios, inductor circuitry in output filter 32 may include an air-coil inductor that includes a coil of wire without soft-magnetic core material (e.g., ferrites or powder iron). In practice, air-coil inductors may exhibit insufficient inductance to suitably limit the peak-to-peak variation in signal V_{OUT} (e.g., air-coil inductors may not exhibit sufficient inductance to limit the peak-to-peak variation of signal V_{OUT} to less than 2% of the average magnitude of signal V_{OUT}).

In other scenarios, the inductor in output filter 32 is provided with a so-called “soft” ferromagnetic material core to increase the total inductance of the inductor relative to air coil inductors. The soft ferromagnetic material may be a material such as annealed iron. The soft ferromagnetic core may be wrapped in a coil of wire and may produce a magnetic field when the wire is provided with a suitable electrical current. The magnetic field produced in the core when the wire is fed with electrical current may contribute to the overall inductance of the inductor. In general, the soft ferromagnetic material becomes magnetic when the coil is provided with a current and loses its magnetism when the coil is not provided with a current. While forming the inductors with a soft ferromagnetic core material can increase the total inductance of the inductor relative to air-coil inductors, wrapping a coil of wire around a core material such as the soft ferromagnetic core material can occupy excessive space on the printed circuit. As space is at a premium within electronic devices such as device 10, it would be desirable to be able to provide voltage converter circuitry 22 with a sufficiently high inductance while also satisfying space constraints within device 10.

If desired, output filter circuitry 32 may be provided with permanent magnet structures such as one or more permanent magnets 34. Permanent magnets 34 may be include so-called “hard” ferromagnetic materials such as alnico and neodymium. Unlike soft ferromagnetic materials, permanent magnets and hard ferromagnetic materials achieve their magnetic properties during manufacture or creation of the materials and do not require application of any external electrical current to become magnetic. In addition, permanent magnets and hard ferromagnetic materials will not lose their magnetism over time (e.g., assuming the materials are not heated above a corresponding Curie temperature).

Permanent magnet structure 34 may apply a magnetic field to inductor circuitry within output filter 32. The magnetic field generated by structure 34 may interact with a magnetic field generated by passing a current through the inductor circuitry to increase the total inductance of the inductor circuitry. Output filter circuitry 32 having permanent magnet 34 may exhibit sufficient inductance such that the peak-to-peak variation in output voltage V_{OUT} is suitably low (e.g., less than 2% of the average magnitude of voltage V_{OUT}). In general, permanent magnet structure 34 may occupy less total space than an inductor wrapped around a soft ferromagnetic core material (e.g., while providing for a greater total inductance than when an air-core inductor is used). Permanent magnet structures 34 may include any desired number of discrete permanent magnets (e.g., one magnet, two magnets, three magnets, four magnets, more than four magnets, etc.). Power switching circuitry 30 and output filter circuitry 32 may be arranged on printed circuit substrate 18 to further reduce the area occupied by voltage converter 22 relative to scenarios where soft ferromagnetic core inductors or air-coil inductors are used.

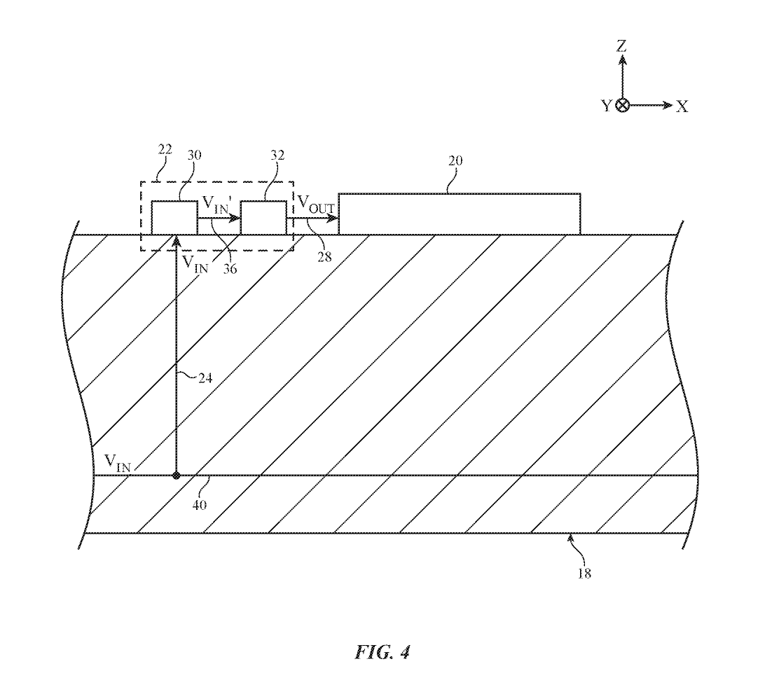

FIG. 4 is a cross-sectional diagram showing how voltage converter circuitry 22 having permanent magnet structures may be formed on a top surface of a printed circuit substrate. As shown in FIG. 4, printed circuit substrate 18 may include powering path 40. Powering path 40 may be embedded within or between dielectric layers on printed circuit 18. Path 40 may include, for example, a conductive powering plane that extends across printed circuit 18 or other conductive structures on printed circuit 18.

Device component 20 and voltage converting circuit 22 may be formed on the top surface of printed circuit. Power switching circuitry 30 may receive device power supply voltage V_{IN} from power plane 40 over powering line 24. Powering line 24 may include, for example, vertical conductive via structures extending through one or more dielectric layers of printed circuit 18, conductive trace structures, conductive wires, conductive contact pads, solder structures, or any other desired vertical conductive interconnect structures. Voltage converting circuit 22 may generate intermediate signals V_{IN}′ based on device power supply voltage V_{IN}. Power switching circuit 30 may transmit intermediate signals V_{IN}′ to output filter circuitry 32 over conductive path 36. Output filter circuitry 32 may generate output voltage V_{OUT} based on signals V_{IN}′ and may transmit output voltage V_{OUT} over path 28 to a power input of component 20 for powering component 20. Conductive paths 36 and 28 may include, for example, conductive traces on printed circuit 18, conductive wiring structures formed in or over printed circuit 18, solder structures, conductive spring structures, contact pad structures, or any other desired conductive interconnect structures.

Voltage converting circuit 22 having permanent magnet structures 34 may occupy less lateral area on the top surface of printed circuit 18 than when soft ferromagnetic core materials are used (e.g., because output filter 32 having permanent magnets occupies less space for a given inductance than filters having soft ferromagnetic core materials). Reducing the lateral area occupied by circuitry 22 may allow for additional device components to be formed on the surface of printed circuit 18, for example.

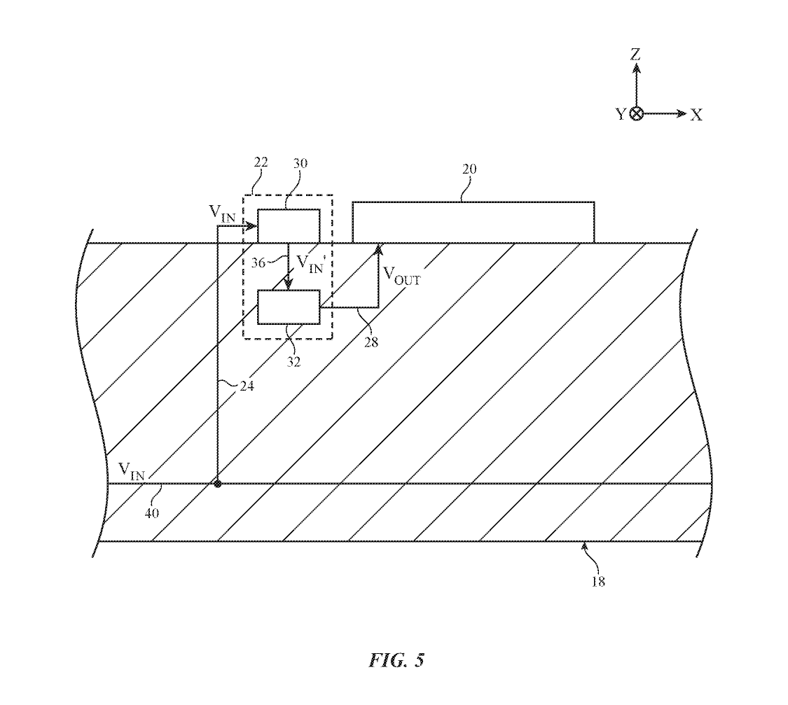

If desired, the lateral area occupied by converter circuitry 22 at the top surface of printed circuit 18 may be further reduced by forming some or all of circuitry 22 within printed circuit 18. FIG. 5 is a cross-sectional diagram showing how output filter circuitry 32 may be formed below power switching circuitry 30. As shown in FIG. 5, power switching circuitry 30 may receive voltage input V_{IN} over path 24. Path 24 in this scenario may include only vertical conductive interconnects or a combination of vertical conductive interconnects and conductive trace structures formed on the top surface of printed circuit 18.

Power switching circuit 30 may convey intermediate signal V_{IN}′ to output filter circuitry 32 over conductive path 36. Conductive path 36 in the example of FIG. 5 may include vertical conductive interconnect structures. Output filter circuitry 32 may convey output voltage V_{OUT} to power component 20 via output path 28. Output path 28 in this example may include a combination of vertical conductive interconnect structures and horizontal conductive traces or wiring structures on one of the dielectric layers of printed circuit 18. The arrangement of converter circuitry 22 in the example of FIG. 5 may occupy less area on the surface of printed circuit 18 than the arrangement shown in FIG. 4 in which filter 32 and switching circuitry 30 are both formed on the top surface of printed circuit 18.

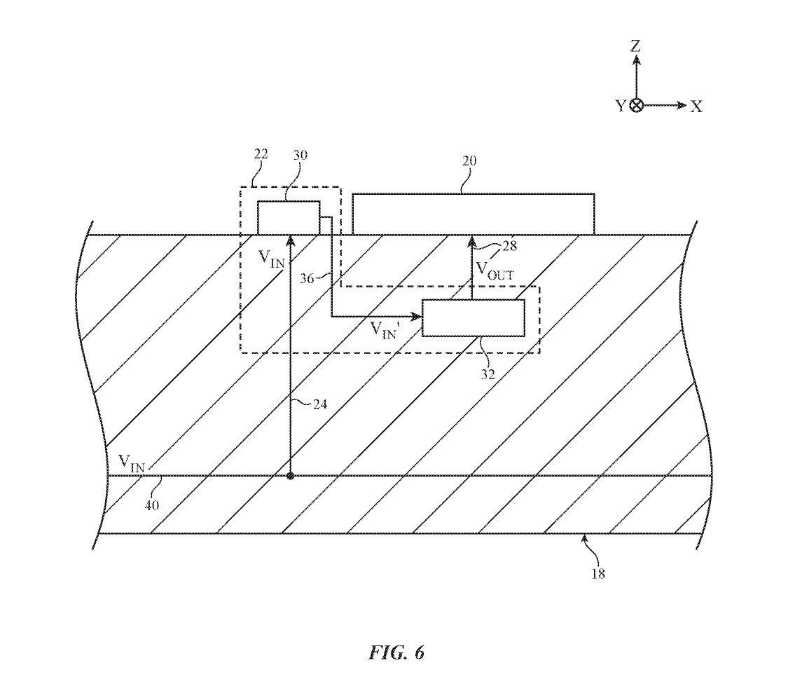

If desired, output filter circuitry 32 may be formed directly below component 20. As shown in FIG. 6, power switching circuitry 30 may be formed on the top surface of printed circuit 18 whereas output filter circuitry 32 is embedded within printed circuit 18 at a location that is directly below component 20 (e.g., without forming circuitry 32 directly below switching circuitry 30). In this example, paths 24 and 28 may be formed from vertical conductive interconnects whereas path 36 is formed form a combination of vertical conductive interconnects and conductive traces on one or more layers of printed circuit 18. The arrangement of FIG. 6 may allow, for example, for output filter circuitry 32 to provide powering voltage V_{OUT} to power input terminals located on the bottom side of component 20 (e.g., powering pins or powering contact pads on the bottom surface of component 20).

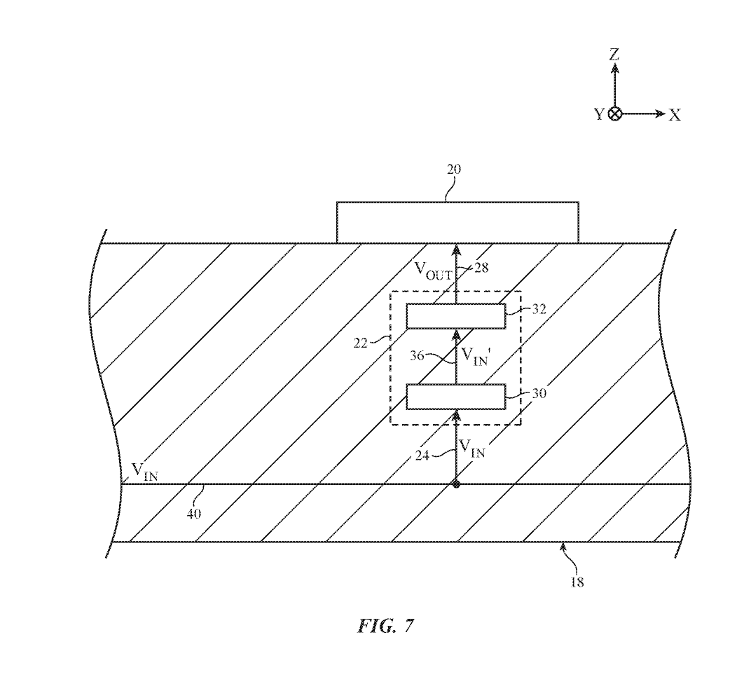

In another suitable arrangement, voltage converter circuitry 22 may be formed entirely beneath powered component 20. As shown in FIG. 7, both power switching circuitry 30 and output filter 32 may be embedded within printed circuit 18 directly below component 20. Circuits 30 and 32 may, for example, be formed on two different layers of printed circuit 18. Paths 24, 36, and 28 may each include vertical conductive interconnect structures (e.g., conductive through-via structures, etc.). The arrangement shown in FIG. 7 may occupy no lateral area on the surface of printed circuit 18, thereby freeing more space on the surface of printed circuit 18 for other device components relative to the arrangements shown in FIGS. 4-6 in which power switching circuitry 30 is formed on the top surface of printed circuit 18. The examples of FIGS. 4-7 are merely illustrative. In general, any desired combination of vertical and/or horizontal interconnect structures may be used to form paths 24, 36, and 28. Such arrangements may allow voltage converter circuitry 22 to be formed suitably near to powered component 20 (e.g., so that converter 22 serves as a point-of-load converter that powers component 20 without significant power losses).

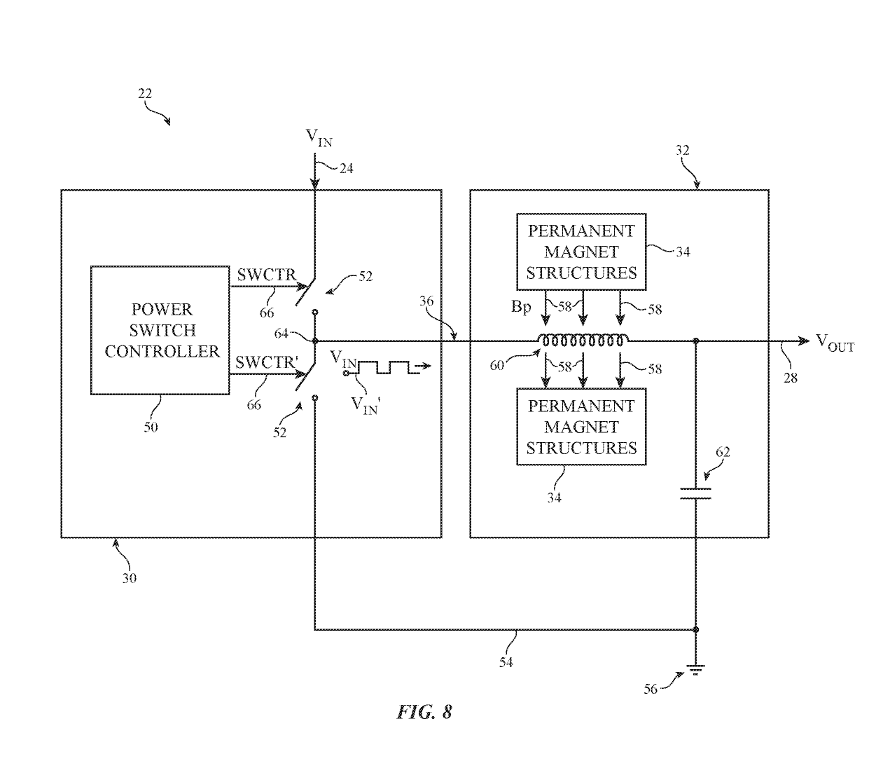

FIG. 8 is an illustrative circuit diagram showing how power switching circuitry 30 and output filter circuitry 32 may generate output powering voltage V_{OUT} based on input voltage V_{IN}. As shown in FIG. 8, power switching circuitry 30 may include control circuitry such as power switch controller 50 and switching circuitry such as power switches 52. Output filter 32 may include an inductive structure such as inductor 60. Power switch controller 50 may be coupled to control terminals on switches 52 via switch control paths 66. Switches 52 may be coupled to ground terminal 56 via ground path 54. Intermediate path 36 may be coupled to node 64 between switches 52.

Power switch controller 50 may generate control signals SWCTR and SWCTR′ and may provide signals SWCTR and SWCTR′ to control each respective switch 52 over paths 66. Controller 50 may control application of power to inductor 60 and may control release or transfer of stored power on inductor 60 to output path 28 by controlling switches 52. Controller 50 may control the release of power from inductor 60 to output path 28 such that a desired output voltage V_{OUT} is produced on output path 28. For example, controller 50 may repeatedly toggle switches 52 with a desired duty cycle frequency using control signals SWCTR and SWCTR′ (e.g., so that node 64 is cyclically coupled to one of input path 24 and ground terminal 56 at a given time). By toggling switches 52 in this manner, intermediate signal V_{IN}′ may be generated at node 64. Intermediate signal V_{IN}′ may have a frequency given by the duty cycle imposed by controller 50. Signal V_{IN}′ may cyclically vary between a minimum voltage (e.g., a ground voltage or 0.0V as supplied over terminal 56) and a maximum voltage given by the magnitude of input signal V_{IN} (e.g., 12V). Intermediate signal V_{IN}′ may be passed to output filter circuitry 32 over path 36.

Output filter circuitry 32 may include inductor structure 60 having a first terminal coupled to path 36 and a second terminal coupled to output path 28. Capacitive structures such as capacitor 62 may, if desired, be coupled between output path 28 and ground terminal 56. Capacitor 62 may, for example, smooth high frequency variations or noise in output signal V_{OUT}. Permanent magnet structures 34 may be placed in the vicinity of inductor structure 60 (e.g., adjacent to inductor 60, on two or more sides of inductor 60, etc.). In general, permanent magnet structures 34 may be formed at a location such that inductor 60 is located within the magnetic field of permanent magnet structures 34. Inductor 60 may include one or more conductive lines. For example, inductor 60 may include one or more conductive wires adjacent to permanent magnet structures 34 (e.g., one or more straight wires without any bends or coils).

As shown in FIG. 8, permanent magnet structures 34 may generate a magnetic field B_{P} as shown by magnetic field lines 58. Permanent magnet structures 34 may include, for example, two magnets formed on either side of inductor 60. In general, any desired number of magnets may be used. Because permanent magnetic structures 34 are formed using hard ferromagnetic materials, magnets 34 need not be provided with electrical current to generate magnetic field B_{P}. This may allow inductor 60 to be formed without winding any wire around magnets 34, thereby reducing the total area occupied by output filter circuitry 32 relative to scenarios where soft ferromagnetic cores are used.

Inductor 60 generates a corresponding magnetic field when a current is applied through inductor 60 (e.g., when intermediate signals V_{IN}′ are provided to output filter 32). The magnetic field generated by passing a current through inductor 60 may sometimes be referred to herein as inductor magnetic field B_{L} or wire magnetic field B_{L}. The magnetic field B_{L} generated by inductor 60 may interact (e.g., combine) with permanent magnetic field B_{P} to increase the overall inductive effect of inductor 60. For example, magnetic field B_{L} of inductor 60 may interact with permanent magnetic field B_{P} (e.g., due to Lorenz forces) to reduce the mobility of charge carriers (e.g., electrons) conveyed over inductor 60. This may result in an increase in the inductance of inductor 60 relative to scenarios where no permanent magnets 34 are formed. In this way, the inductance of inductor 60 may be sufficiently high (e.g., such that peak-to-peak voltage variations on output signal V_{OUT} are acceptably low) without occupying excessive space within device 10. Output signal V_{OUT} may be conveyed to component 20 for powering component 20 over path 28. The example of FIG. 8 is merely illustrative. In general, the components of FIG. 8 may be coupled together in any desired arrangement. If desired, additional switches may be formed in switching circuitry 30 and/or output filter 32.

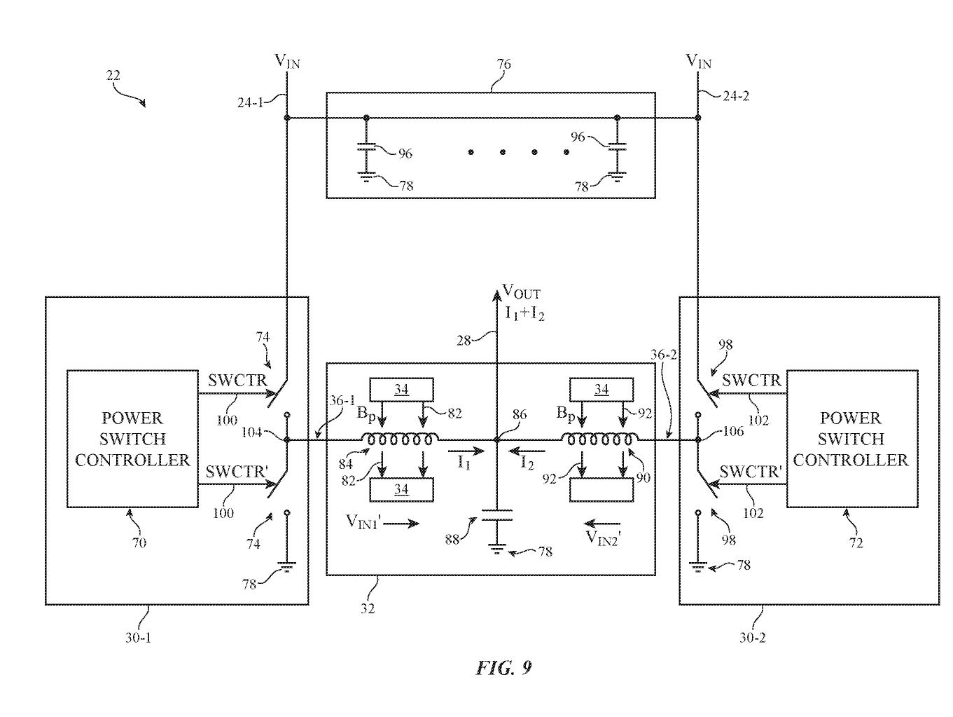

In the example of FIG. 8, voltage converter circuit 22 is formed using a single phase converter architecture in which a single pair of power switches is used to generate output signal V_{OUT}. If desired, voltage converter circuit 22 may be formed using a multiphase converter architecture in which multiple pairs of power switches are used. FIG. 9 is an illustrative circuit diagram showing how voltage converter circuit 22 may be formed using a two-phase converter architecture in which two pairs of power switches are used.

As shown in FIG. 9, power switching circuitry 30 may include first and second power switching circuits 30-1 and 30-2. Output filter circuitry 32 may be coupled between first and second circuits 30-1 and 30-2. First power switching circuit 30-1 may receive input voltage V_{IN} over a corresponding input line 24-1 whereas second power switching circuit 30-2 receives input voltage V_{IN} over corresponding input line 24-2. Voltage converter circuitry 22 may include input decoupling capacitor structures 76. Decoupling capacitor structures 76 may be coupled between input lines 24-1 and 24-2. Decoupling capacitors 76 may include one or more decoupling capacitors 96 (e.g., capacitors 96 coupled between lines 24-1 and 24-2 and ground 78). Decoupling capacitors 96 may decouple high frequency noise signals at input lines 24 from power switching circuitry 30 (e.g., by shorting the noise signals to ground 78).

First power switching circuit 30-1 may include power switch controller 70. Circuit 30-1 may include a corresponding pair of power switches 74 coupled between input line 24-1 and ground terminal 78. Controller 70 may control transfer of power from input 24-1 to inductor 84 and from inductor 84 onto output path 28 by toggling switches 74. For example, controller 70 may toggle switches 74 using a desired duty cycle by providing control signals SWCTR and SWCTR′ to respective switches 74 over control paths 100. In this way, a first intermediate signal V_{IN1}′ may be generated at node 104 between switches 74 at the desired duty cycle. Node 104 may be coupled to output filter circuitry 32 over path 36-1. Intermediate signal V_{IN1}′ may be transmitted to output filter circuitry 32 over path 36-1.

Second power switching circuit 30-2 may include a corresponding power switch controller 72. Circuit 30-2 may include a pair of power switches 98 coupled between input line 24-2 and ground terminal 78. Controller 72 may control transfer of power from input 24-2 to inductor 90 and from inductor 90 onto output path 28 by toggling switches 98. For example, controller 72 may toggle switches 98 using a desired duty cycle (e.g., the same duty cycle as provided by controller 70 or a different duty cycle than that provided by controller 70) by providing control signals SWCTR and SWCTR′ to respective switches 98 over control paths 102. In this way, a second intermediate signal V_{IN2}′ may be generated at node 106 between switches 98 at the desired duty cycle. Node 106 may be coupled to output filter circuitry 32 over path 36-2. Intermediate signal V_{IN2}′ may be transmitted to output filter circuitry 32 over path 36-2.

Output filter circuit 32 may include a first inductive structure 84, a second inductive structure 90, an output node 89, capacitive structures such as capacitor 88, and permanent magnet structures 34. First inductive structure 84 may be coupled between path 36-1 and output node 86. Second inductive structure 90 may be coupled between path 36-2 and output node 86. Capacitor 88 may be coupled between output node 86 and ground 78. Output node 86 may be coupled to powered component 20 over output path 28.

Permanent magnet structures 34 may be formed adjacent to first inductor 84 and adjacent to second inductor 90. For example, magnets 34 may be formed such that inductors 84 and 90 are located within the magnetic field of magnets 34. Permanent magnet structures 34 may generate magnetic field B_{P} such that field B_{P} passes through inductive structures 84 (e.g., as shown by magnetic field lines 82) and through inductive structures 90 (e.g., as shown by magnetic field lines 92). Magnetic field B_{P} may interact with the magnetic field B_{L} generated by inductors 84 and 90 to increase the overall inductive effect (e.g., the inductance value) of the inductors. Signals V_{IN1}′ may be provided to output terminal 86 at current level I₁ whereas signals V_{IN2}′ are provided to output terminal 86 at current level I₂. The signals provided over inductor 84 may combine with the signals provided over inductor 90 to generate output voltage V_{OUT}. Output voltage V_{OUT} may be output at current level I=I₁+I₂, for example. In this way, the output current may be shared between each inductor and between each power switching circuit. Output voltage V_{OUT} may be provided to power component 20 over line 28.

Power switching circuits 30-1 and 30-2 may be formed from separate circuits or may be formed from shared circuitry. For example, circuits 30-1 and 30-2 may be formed on two separate integrated circuit chips. In another suitable arrangement, both switching circuits 30-1 and 30-2 are formed on a single integrated circuit chip. If desired a single power switch controller may control both sets of switches 74 and 98. Switches 74 and 98 may include, for example, transistor-based switches such as metal oxide semiconductor field effect transistors (MOSFETS) or any other desired type of switching components. The example of FIG. 9 in which two sets of power switches is used is merely illustrative. If desired, converter 22 may be a multiphase converter having any desired number of switches and switch controllers. In general, the components of FIG. 9 may be arranged in any desired manner. If desired, other switches may additionally be formed within output filter circuitry 32 and/or switching circuitry 30.

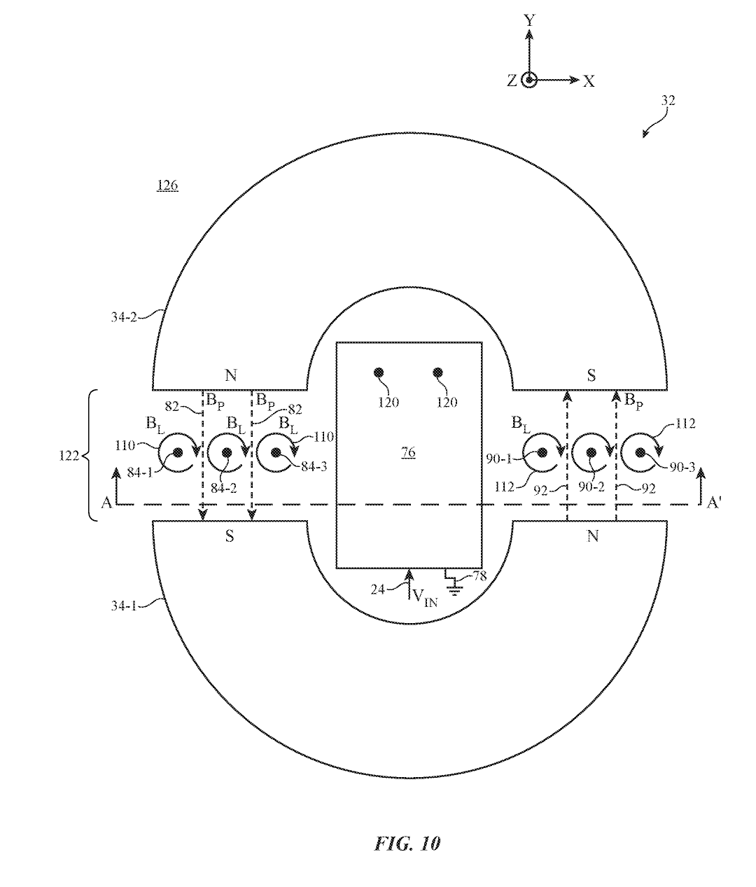

FIG. 10 is an illustrative diagram showing how permanent magnets 34 may interact with adjacent inductive structures in output filter 32. As shown in FIG. 10, output filter circuit 32 may include first and second permanent magnets 34-1 and 34-2. This example is merely illustrative and, in general, any desired number of permanent magnets may be formed. Magnets 34 may have any desired shapes (e.g., a semi-circular shape, a rectangular shape, a bar shape, a donut shape, a toroidal shape, a semi-toroidal shape, a square shape, a cylindrical shape, etc.). First permanent magnet 34-1 may be separated from second permanent magnet 34-2 by gap 122. A north (N) pole face of permanent magnet 34-2 may be aligned with a corresponding south (S) pole face of permanent magnet 34-1. Similarly, the south pole face of permanent magnet 34-2 may be aligned with the north pole face of magnet 34-1. Permanent magnets 34-1 and 34-2 may produce corresponding magnetic field B_{P} across gap 122 (e.g., as shown by magnetic field lines 82 between the north pole of magnet 34-2 and the south pole of magnet 34-1 and by magnetic field lines 92 between the north pole of magnet 34-1 and the south pole of magnet 34-2). Inductor 84 may be formed within gap 122 between the north pole of permanent magnet 34-2 and the south pole of permanent magnet 34-1. Inductor 90 may be formed in gap 122 between the north pole of permanent magnet 34-1 and the south pole of permanent magnet 34-2.

Inductor 84 may include one or more conductive lines. For example, inductor 84 may include a number of conductive wires (e.g., straight conductive wires without any coils or bends) extending in the direction of the z-axis of FIG. 10 (e.g., perpendicular to the direction of magnetic field B_{P}). In general, inductor 84 may be oriented substantially perpendicular to the direction of magnetic field B_{P} or at any desired angle that is greater than 45 degrees with respect to field B_{P} (e.g., at a 90 degree angle with respect to field B_{P}, at an angle between 60 and 90 degrees with respect to field B_{P}, etc.). In the example of FIG. 10, inductor 84 includes three wires 84-1, 84-2, and 84-3. In general, any desired number of wires may be used (e.g., one wire, two wires, four wires, more than four wires). A first end of wires 84-1, 84-2, and 84-3 may be coupled to node 104 of power switching circuitry 30-1 (FIG. 9). A second end of wires 84-1, 84-2, and 84-3 may be coupled to output path 28 (e.g., conductors 84-1, 84-2, and 84-3 may be coupled in parallel between node 104 and path 28 of FIG. 9). Wires 84-1, 84-2, and 84-3 may exhibit an inductance while conveying a corresponding current (e.g., while conveying signals V_{IN1}′). While conveying signals V_{IN1}′, wires 84 may generate wire magnetic field B_{L} as shown by magnetic field lines 110. Magnetic field B_{L} may by in a direction perpendicular to the axis of wires 84, for example. Magnetic field B_{P} of permanent magnets 34 may interact with magnetic field B_{L} of wires 84 to reduce the mobility of charge carriers on wires 84, thereby increasing the inductance of wires 84 relative to scenarios where no permanent magnet structures are formed.

Inductor 90 may include one or more conductive lines. For example, inductor 90 may include a number of conductive wires (e.g., straight conductive wires) extending in the direction of the z-axis of FIG. 10 (e.g., substantially perpendicular to the direction of field lines 92). In the example of FIG. 10, inductor 90 includes three wires 90-1, 90-2, and 90-3. In general, any desired number of wires may be used (e.g., one wire, two wires, four wires, more than four wires, ten wires, hundreds of wires, etc.). A first end of wires 90-1, 90-2, and 90-3 may be coupled to node 106 of power switching circuitry 30-2. A second end of wires 90-1, 90-2, and 90-3 may be coupled to output path 28 (e.g., conductors 90-1, 90-2, and 90-3 may be coupled in parallel between node 106 and path 28 of FIG. 9). Wires 90-1, 90-2, and 90-3 may exhibit an inductance while conveying a current (e.g., while conveying signals V_{IN2}′). While conveying signals V_{IN2}′, wires 90 may generate wire magnetic field B_{L} as shown by magnetic field lines 112. Magnetic field B_{L} may by in a direction perpendicular to the axis of wires 90, for example. Magnetic field B_{P} of permanent magnets 34 may interact with magnetic field B_{L} of wires 90 to reduce the mobility of charge carriers on wires 90, thereby increasing the inductance of wires 90 relative to scenarios where no permanent magnet structures are formed. By using permanent magnets 34, inductors 84 and 90 need not be wound around a core of magnetic material, thereby reducing the space occupied by filter 32 relative to scenarios where soft ferromagnetic cores are used). Permanent magnets 34 may allow the total length of wires 84 and 90 to be reduced relative to scenarios where no permanent magnets are formed (e.g., for a given amount of inductance).

If desired, decoupling capacitor structures 76 may be formed between permanent magnets 34 (e.g., in a portion of gap 122 that is not strongly permeated by magnetic field B_{P}). Capacitor structures 76 may be coupled to switching circuits 30-1 and 30-2 via contact pads 120. Capacitor structures 76 may receive input voltage V_{IN} via path 24 and may be coupled to ground terminal 78. Capacitor structures 76 may have any desired shape. For example, capacitor structures 76 may fill an entirety of the portion of gap 122 that is between magnets 34 and inductors 90 and 84.

In the example of FIG. 10, inductors 84 and 90 are coupled to two power switching circuits 30-1 and 30-2 as described in connection with FIG. 9. If desired, the arrangement of FIG. 10 may be applied to the single phase architecture of FIG. 8. For example, inductors 84 and 90 may be coupled together to form a single inductor that is coupled to a single switching circuit 30. Magnets 34, inductors 84 and 90, and capacitors 76 may be formed on substrate 126. Substrate 126 may, for example, be printed circuit 18 or a corresponding substrate layer within printed circuit 18. If desired, inductor 84 may include a different number of parallel wires than inductor 90.

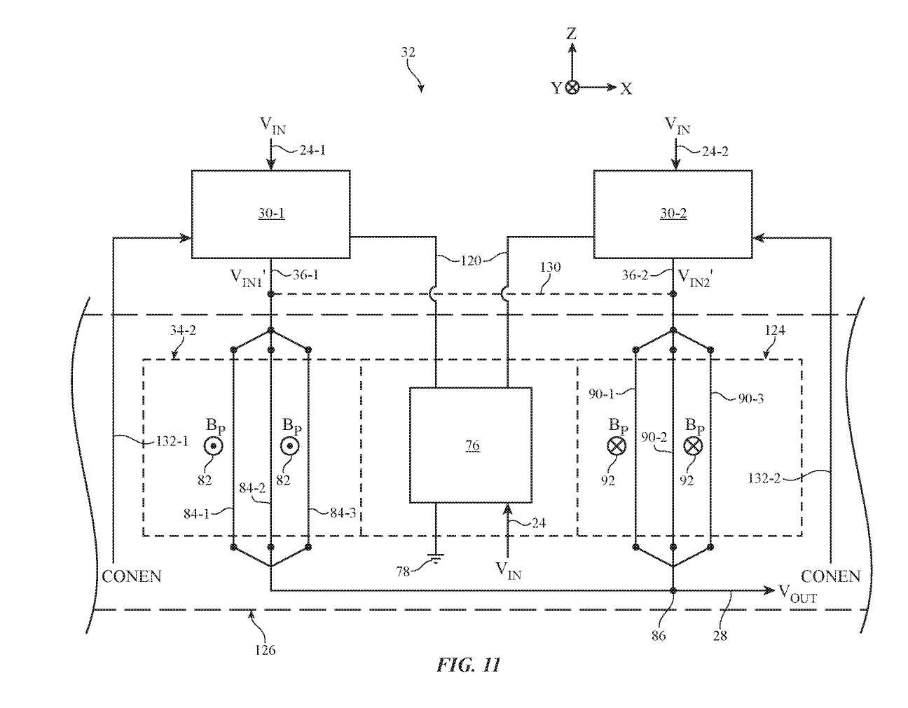

FIG. 11 is an illustrative cross-sectional diagram of a permanent magnet output filter of the type shown in FIG. 10 (e.g., as taken along dashed line AA′ of FIG. 10). As shown in FIG. 11, inductors 84 and 92, decoupling capacitor structures 76, and permanent magnet 34-2 may be embedded within substrate 126. Substrate 126 may be, for example, printed circuit 18 or a layer of printed circuit 18. In another suitable arrangement, substrate 126 may be formed on top of printed circuit 18 (e.g., in the example of FIG. 4). In yet another suitable arrangement, permanent magnet 34, inductors 84 and 92, and capacitor structures 76 may be formed without any corresponding substrate 126. Magnets 34-1 and 34-2 as shown in FIG. 10 may, if desired, be replaced with other magnetic structures (e.g., non-permanent magnets, permanent magnets, or combinations of these).

Power switching circuits 30-1 and 30-2 may be formed above substrate 126. Circuits 30-1 and 30-2 may, for example, be mounted to substrate 126 and may be conductively coupled to inductors 84 and 90 via any desired conductive structures (e.g., solder ball structures, ball grid array structures, wiring structures, conductive pin structures, contact pad structures, etc.). Conductive wires 84-1, 84-2, and 84-3 may extend through substrate 126 in the direction of the z-axis of FIG. 11 (e.g., between path 36-1 and output path 28). Permanent magnetic field B_{P} may be generated in the opposite direction as the y-axis as shown by magnetic field lines 82. Magnetic field B_{P} may interact with the magnetic field B_{L} of inductive wires 84 while wires 84 convey signals V_{IN1}′ to increase the inductive effect of wires 84.

Conductive wires 90-1, 90-2, and 90-3 may extend through substrate 126 in the direction of the z-axis between path 36-2 and output path 28. Permanent magnetic field B_{P} may be generated in the direction of the y-axis as shown by magnetic field lines 92. Magnetic field B_{P} may interact with the magnetic field B_{L} of inductive wires 90 while wires 90 convey signals V_{IN2}′ to increase the inductive effect of wires 90. Inductors 90 and 84 may be coupled to output line 28 using any desired conductive interconnect structures (e.g., solder ball structures, ball grid array structures, wire structures, conductive pin structures, contact pad structures, etc.). Output signal V_{OUT} may be generated using the output of inductors 84 and 90 and may be provided to component 20 over path 28. If desired, conversion enable signals CONEN may be provided to switching circuits 30-1 and 30-2 over respective interconnects 132-1 and 13-2. When asserted, signals CONEN may enable voltage conversion operations by converter circuit 22. When deasserted, converter circuit 22 may not perform any voltage conversion operations.

The example of FIG. 11 is merely illustrative. In general, inductors 84 and 90 may include any desired number of parallel-coupled wires. Permanent magnet 34-2 may be arranged in any desired manner relative to inductors 84 and 90. Inductors 84 and 90 may have any desired shape and orientation relative to permanent magnet 34-2. If desired, a conductive path shown by dashed line 130 may couple path 36-1 to path 36-2 to form a single-phase architecture as shown in FIG. 8. In this scenario, only one power switching circuit 30 need be formed.

By forming a number of voltage converter circuits across printed circuit 18 in device 10, different device components 20 may be provided with different corresponding power supply voltages V_{OUT} based on a single device power supply voltage V_{IN}. By forming permanent magnets 34 adjacent to inductive structures in output filters 32, the inductance of the inductive structures may be increased relative to scenarios where an air-filled inductor is used. The use of hard ferromagnetic materials such as permanent magnets may allow filters 32 to be formed without any soft ferromagnetic materials (e.g., converter circuits 22 may include only hard ferromagnetic material without any soft ferromagnetic material) and without sacrificing the total inductance of the filter (e.g., so that output voltage V_{OUT} has acceptable peak-to-peak variation). Forming filters 32 without soft ferromagnetic materials may allow the inductors to be formed without corresponding wire coils wrapped around a soft ferromagnetic core, thereby reducing the total space required to form filter 32 relative to scenarios where soft ferromagnetic cores are used. Space occupied by filter 32 and converter circuit 22 may further by reduced using the power switch and filter arrangements of FIGS. 4-7. Space conserved by forming voltage converter circuits 22 with permanent magnets may allow further reduction in the size of device 10 and/or for additional device components to be formed within device 10 relative to scenarios where the voltage converters are provided with soft ferromagnetic materials.

The foregoing is merely illustrative and various modifications can be made by those skilled in the art without departing from the scope and spirit of the described embodiments. The foregoing embodiments may be implemented individually or in any combination.

What is claimed is:

1. Voltage converter circuitry, comprising:
a permanent magnet, wherein the permanent magnet has first and second poles and produces a magnetic field;
a conductive line having an inductance, wherein the conductive line is adjacent to the first pole of the permanent magnet and the magnetic field contributes to the inductance; and
control circuitry, wherein the control circuitry receives an input voltage and controls transfer of power from the conductive line to an output based at least on the input voltage.

2. The voltage converter circuitry defined in claim 1, wherein the permanent magnet comprises a hard ferromagnetic material.

3. The voltage converter circuitry defined in claim 2, wherein the hard ferromagnetic material comprises ferrite.

4. The voltage converter circuitry defined in claim 2, wherein the voltage converter circuitry is formed without any soft ferromagnetic materials.

5. The voltage converter circuitry defined in claim 1, wherein the control circuitry comprises:
switching circuitry, wherein the switching circuitry generates an intermediate signal by applying a duty cycle to the input voltage, the conductive line receives the intermediate signal from the control circuitry, and the conductive line generates an output voltage at the output based on the intermediate signal.

6. The voltage converter circuitry defined in claim 5, wherein the conductive line comprises a plurality of wires that are coupled in parallel between the control circuitry and the output path.

7. The voltage converter circuitry defined in claim 6, wherein the magnetic field extends in a first direction from the first pole of the permanent magnet, the plurality of wires extend in a second direction between the control circuitry and output, and the second direction is substantially perpendicular to the first direction.

8. The voltage circuitry defined in claim 1, wherein the conductive line comprises a set of straight wires that extends substantially perpendicular to a direction of the magnetic field.

9. The voltage converter circuitry defined in claim 1, further comprising:
an additional conductive line having an additional inductance, wherein the additional conductive line is adjacent to the second pole of the permanent magnet and the magnetic field contributes to the additional inductance.

10. A voltage converter that converts an input voltage to an output voltage for powering an electrical component, comprising:
a first magnet having a first north pole and a first south pole;
a second magnet having a second north pole and a second south pole, wherein the first north pole is separated from the second south pole by a gap;
an inductive structure, wherein the inductive structure is formed in the gap between the first north pole and the second south pole; and
control circuitry, wherein the control circuitry receives the input voltage and is configured to control the inductive structure to power the electrical component using the output voltage.

11. The voltage converter circuitry defined in claim 10, wherein the first south pole is separated from the second north pole by the gap.

12. The voltage converter circuitry defined in claim 11, further comprising:
an additional inductive structure, wherein the additional inductive structure is formed in the gap and between the second north pole and the first south pole.

13. The voltage converter circuitry defined in claim 12, wherein the inductive structure and the additional inductive structure comprise a plurality of straight wires in the gap.

14. The voltage converter circuitry defined in claim 12, wherein the control circuitry further comprises:
first power switching circuitry that receives the input voltage over a first input path, wherein the first power switching circuitry generates a first intermediate signal by applying a first duty cycle to the input signal, and wherein the first power switching circuitry conveys the first intermediate signal to the inductor; and
second power switching circuitry that receives the input voltage over a second input path, wherein the second power switching circuitry generates a second intermediate signal by applying a second duty cycle to the input signal, and wherein the second power switching circuitry conveys the second intermediate signal to the additional inductor.

15. The voltage converter circuitry defined in claim 14, further comprising:
decoupling capacitor circuitry coupled between the first and second input paths, wherein the decoupling capacitor is formed within the gap.

16. The voltage converter circuitry defined in claim 14, wherein the inductive structure extends in a first direction between the first power switching circuitry and an output path that is coupled to the electrical component, the additional inductor extends in the first direction between the second power switching circuitry and the output path, the first and second magnets generate a magnetic field that extends between the first north pole and the second south pole in a second direction and that extends between the second north pole and the first south pole in a third direction that is opposite to the second direction, and wherein the first and third directions are substantially perpendicular to the second direction.

17. The voltage converter circuitry defined in claim 11, wherein the first magnet comprises a first permanent magnet and the second magnet comprises a second permanent magnet.

18. A system, comprising:
a first permanent magnet;
a second permanent magnet, wherein the first and second permanent magnets produce a magnetic field;
inductive structures formed between the first and second permanent magnets and within the magnetic field;
switching circuitry that receives an input voltage and that generates an intermediate signal based on the input voltage, wherein the inductive structures generate a power supply voltage based at least on the generated intermediate signal; and
an electrical component, wherein the electrical component is powered using the generated power supply voltage.

19. The system defined in claim 18, further comprising:
a printed circuit, wherein the inductive structures and the switching circuitry are formed on a surface of the printed circuit adjacent to the electrical component.

20. The system defined in claim 18, further comprising:
a printed circuit, wherein the inductive structures are embedded within the printed circuit and the switching circuitry is formed on a surface of the printed circuit adjacent to the electrical component.

21. The system defined in claim 18, further comprising:
a printed circuit, wherein the electrical component is formed on a surface of the printed circuit, and the inductive structures and the switching circuitry are embedded within the printed circuit directly below the electrical component.

22. The system defined in claim 18, further comprising:
a third permanent magnet;
a fourth permanent magnet, wherein the third and fourth permanent magnets produce an additional magnetic field;
additional inductive structures formed between the third and fourth permanent magnets and within the additional magnetic field;
additional switching circuitry that receives the input voltage and that generates an additional intermediate signal based on the input voltage, wherein the additional inductive structures generate an additional power supply voltage based at least on the generated intermediate signal, and the additional power supply voltage is different from the power supply voltage; and
an additional electrical component, wherein the additional electrical component is powered using the additional power supply voltage.
